(19) United States
(12) Patent Application Publication
(10) Pub. No.: US 2007/0101588 A1
(43) Pub. Date: May 10, 2007

(54) Handsaw assembly

(75) Inventor: Peter (Hao) Wen, Shanghai (CN)

Correspondence Address: EDMONDS, P.C., 16815 ROYAL CREST DRIVE, SUITE 130, HOUSTON, TX, 77058, US

(73) Assignee: KRAFTOOL MFG. (SHANGHAI) CO., LTD., SHANGHAI (CN)

(21) Appl. No.: 11/586,342

(22) Filed: Oct. 25, 2006

(30) Foreign Application Priority Data
Oct. 26, 2005 (CN) 200510030725.6

(51) Int. Cl. B27B 21/06

(52) U.S. Cl. 30/513

(57) ABSTRACT

A handsaw assembly that can prevent skin abrasion by reducing friction and heat between the handle and the hand of the operator is provided. The handsaw assembly includes a saw blade and a handle. The saw blade and the handle are connected by two rivets. Saw teeth are provided along one edge of the saw blade. There is a hand hole in the handle. The handsaw assembly includes at least two rows and two columns of through holes formed outside the hand hole of the handle.

### CROSS REFERENCE TO RELATED APPLICATION

This application claims the benefit under 35 USC §119 of Chinese Patent Application having Serial No. 200510030725.6 filed on Oct. 26, 2005, which is incorporated by reference herein.

### BACKGROUND OF THE INVENTION

1. Field of the Invention

Embodiments of the present invention generally relate to a handsaw assembly. More particularly, embodiments of the present invention relate to a handsaw assembly that can prevent skin abrasion and can be used to cut various types of materials.

1. Description of the Related Art

A conventional handsaw includes a saw blade and a handle. The saw blade and handle are usually fixed together by two rivets. The handle has a polygonal shape and has a hole for the fingers of the operator. Problems with conventional handsaws include difficulty of use, uncomfortable positioning of the handle, and occurrences of skin abrasions while using the saw.

There is a need, therefore, for a handsaw assembly that allows for comfort, ease of use, prevention of skin abrasions, and the ability to cut various materials.

### SUMMARY OF THE INVENTION

In one or more embodiments, the present invention generally relates to a handsaw assembly comprising a saw blade and a handle. The saw blade and the handle can be connected by two rivets. There can be saw teeth on one edge of the saw blade. There can be a hand hole in the handle. The handsaw can have at least two rows and two columns of through holes that can be formed outside the hand hole in the handle. In one or more embodiments, at least two rows and two columns of through holes can be formed outside the hand hole. In this way, heat and friction between the handle and the hand can be reduced to prevent skin abrasion, and at the same time may save material.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic side view of a handsaw assembly in accordance with one or more embodiments described.

FIG. 2 depicts a schematic side view of another handsaw assembly in accordance with one or more embodiments described.

FIG. 3 depicts a schematic side view of another handsaw assembly in accordance with one or more embodiments described.

FIG. 4 depicts a schematic side view of another handsaw assembly in accordance with one or more embodiments described.

FIG. 5 depicts a schematic side view of another handsaw assembly in accordance with one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

In operation, the handle can be grasped in one hand with the user's palm facing the one or more through holes. The user's other hand can hold the edge opposite from the one or more saw teeth. The handsaw can be moved back and forth to process the workpiece.

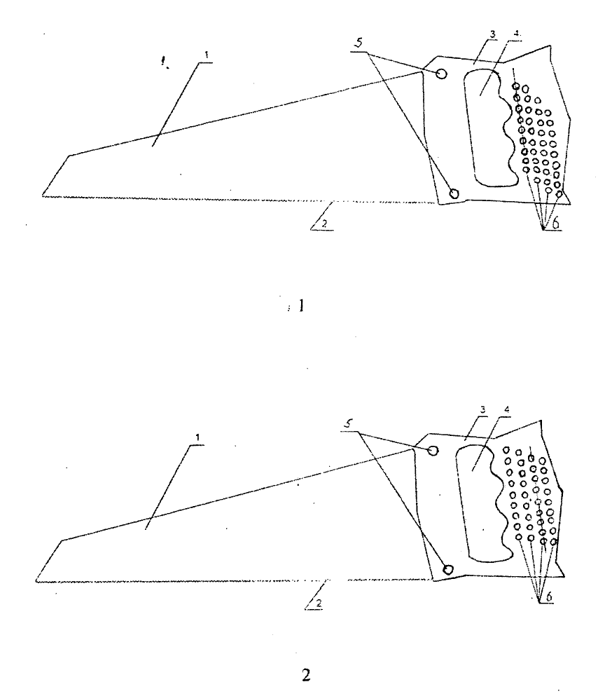

FIG. 1 depicts a schematic side view of a handsaw assembly in accordance with one or more embodiments described. In one or more embodiments, the handsaw assembly includes a saw blade 1 and a handle 3. The saw blade 1 and handle 3 can be connected by one or more rivets 5. In one or more embodiments, one or more saw teeth 2 can be provided along one edge of saw blade 1. In one or more embodiments, a hand hole 4 can be formed in the handle 3. One or more through holes 6 can have identical diameters that can be formed in a diamond pattern outside the hand hole 4 in the handle 3. In one or more embodiments, the through holes 6 can be arranged at a certain angle to reduce heat and friction between the handle and the operator's hand and, at the same time, save material.

FIG. 2 depicts a schematic side view of another handsaw assembly in accordance with one or more embodiments described. In one or more embodiments, the through holes 6 can have identical diameters and can be formed in a parallelogram pattern outside hand hole 4 in the handle 3. In one or more embodiments, the through holes 6 can be arranged in straight lines in the same plane. This type of arrangement of through holes 6 can achieve a maximum cooling area during operation of the handsaw assembly.

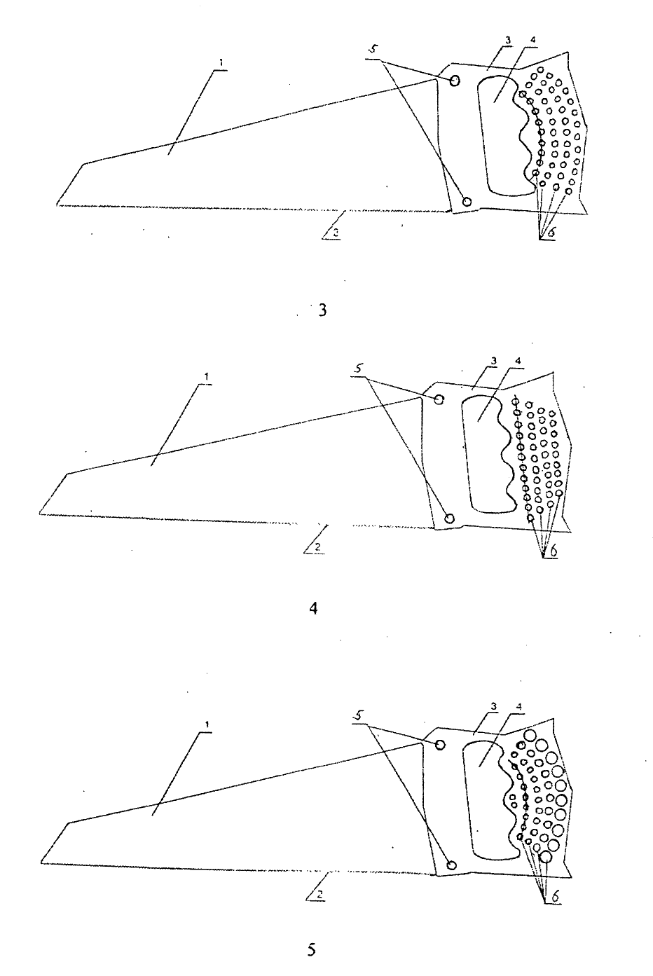

FIG. 3 depicts a schematic side view of another handsaw assembly in accordance with one or more embodiments described. In one or more embodiments, the through holes 6 can have identical diameters and can be formed in a fan pattern outside hand hole 4 in the handle 3. In one or more embodiments, the through holes 6 can be arranged in the form of an arc that can be arranged in the same plane. Such an arrangement can allow for adjusting the method of gripping the handle in the palm and can provide heat dissipation. Accordingly, the positioning of handle 3 can be improved with this arrangement.

FIG. 4 depicts a schematic side view of another handsaw assembly in accordance with one or more embodiments described. In one or more embodiments, the through holes 6 can have identical diameters that can be formed in a trapezoidal pattern outside hand hole 4 in the handle 3. In one or more embodiments, the through holes 6 can be formed in one or more straight lines. In one or more embodiments, the number of through holes 6 can be reduced toward the outside of the pattern. This arrangement of through holes 6 can provide good heat dissipation and can massage the palm.

FIG. 5 depicts a schematic side view of another handsaw assembly in accordance with one or more embodiments described. In one or more embodiments, the through holes 6 can have identical diameters that can be formed in a fan pattern outside hand hole 4 in the handle 3. In one or more embodiments, the diameter of the through holes 6 can be gradually increased toward the outside of the pattern. In one or more embodiments, the through holes 6 with the largest diameter can form the longest arc. With this arrangement, sweat from the palm can flow into larger holes 6. Accordingly, the positioning of the handle 3 can be improved and the assembly weight can be reduced.

In yet another embodiment, the present invention relates to:

1. A handsaw assembly comprising: a saw blade and handle has saw blade and handle connected by at least two screws, the saw blade having saw teeth disposed on one edge thereof, and a hand hole formed in the handle, wherein at least two rows and two columns of through holes are formed about the hand hole in said handle.

2. The handsaw assembly of paragraph 1, wherein the through holes can have the same diameter and can be arranged in a diamond pattern.

3. The handsaw assembly of paragraphs 1 or 2, wherein the through holes can have the same diameter and can be arranged in a parallelogram pattern.

4. The handsaw assembly of paragraphs 1, 2 or 3, wherein the through holes can have the same diameter and can be arranged in a fan pattern.

5. The handsaw assembly of paragraphs 1, 2, 3 or 4, wherein the through holes can have the same diameter and can be arranged in a trapezoidal pattern.

6. The handsaw assembly of any of paragraphs 1 to 5, wherein the diameter of the through holes can be gradually increased toward the outside, and the through holes can be arranged in a fan pattern.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A handsaw assembly comprising: a saw blade and handle has saw blade and handle connected by at least two screws, the saw blade having saw teeth disposed on one edge thereof, and a hand hole formed in the handle, wherein at least two rows and two columns of through holes are formed about the hand hole in said handle.

2. The handsaw assembly of claim 1, wherein the through holes have the same diameter and are arranged in a diamond pattern.

3. The handsaw assembly of claim 1, wherein the through holes have the same diameter and are arranged in a parallelogram pattern.

4. The handsaw assembly of claim 1, wherein the through holes have the same diameter and are arranged in a fan pattern.

5. The handsaw assembly of claim 1, wherein the through holes have the same diameter and are arranged in a trapezoidal pattern.

6. The handsaw assembly of claim 1, wherein the through holes is gradually increased toward the outside, and the through holes are arranged in a fan pattern.
